(19) United States
(12) Patent Application Publication
(10) Pub. No.: US 2025/0291192 A1
(43) Pub. Date: Sep. 18, 2025

(54) VIRTUAL IMAGE DISPLAY DEVICE AND OPTICAL UNIT

(71) Applicant: SEIKO EPSON CORPORATION, Tokyo (JP)

(72) Inventor: Masayuki TAKAGI, AZUMINO-SHI (JP)

(73) Assignee: SEIKO EPSON CORPORATION, Tokyo (JP)

(21) Appl. No.: 19/078,268

(22) Filed: Mar. 12, 2025

(30) Foreign Application Priority Data
Mar. 14, 2024 (JP) 2024-039839

(51) Int. Cl. G02B 27/01; G02B 3/08; G02B 3/12; G02B 5/30; G02F 1/1335; G02F 1/135

(52) U.S. Cl. CPC G02B 27/0172; G02B 3/08; G02B 3/12; G02B 5/3016; G02B 5/3066; G02B 27/0176; G02F 1/133524; G02F 1/133526; G02F 1/133541; G02F 1/1358; G02B 2027/015; G02B 2027/0178

(57) ABSTRACT

A virtual image display device or an optical unit includes a display configured to emit video light, and a polarization-selective lens that is disposed facing the display and that has a refractive power that selectively acts on polarized light of the video light. The polarization-selective lens includes, in order from a display side, a polarizing diffractive lens having a positive refractive power with respect to the video light that is circularly polarized light and having a negative refractive power with respect to external light that is circularly polarized light, and an auxiliary lens having a positive refractive power equivalent to a refractive power of the polarizing diffractive lens.

The present application is based on, and claims priority from JP Application Serial Number 2024-039839, filed Mar. 14, 2024, the disclosure of which is hereby incorporated by reference herein in its entirety.

### BACKGROUND

### 1. Technical Field

The present disclosure relates to a virtual image display device and an optical unit that enable observation of a virtual image, more particularly to a virtual image display device that utilizes a polarizing diffractive lens.

### 2. Related Art

A polarization conversion system provided with a geometric phase element and a retarder element is known (see JP-A-2016-519327). The geometric phase element has optical anisotropy with a local optical axis direction that varies non-linearly in at least one dimension along a surface thereof. The retarder element is disposed so as to receive light output from the geometric phase element.

In the polarization conversion system, the geometric phase element functions to condense right-handed circularly polarized light and functions to diverge left-handed circularly polarized light. Thus, even when the system disclosed in JP-A-2016-519327 is simply applied to the virtual image display device, it is difficult to achieve both video observation and external light observation. In a see-through type virtual image display device, it is necessary to dispose the geometric phase element at a position outside the see-through region, and thus there is a problem in that the optical system becomes large.

### SUMMARY

Each of a virtual image display device and an optical unit according to an aspect of the present disclosure includes a display configured to emit video light, and a polarization-selective lens that is disposed facing the display and that has a refractive power that selectively acts on polarized light of the video light. The polarization-selective lens includes, in order from a display side, a polarizing diffractive lens having a positive refractive power with respect to the video light that is circularly polarized light and having a negative refractive power with respect to external light that is circularly polarized light, and an auxiliary lens having a positive refractive power equivalent to a refractive power of the polarizing diffractive lens.

### BRIEF DESCRIPTION OF THE DRAWINGS

FIG. 1 is an external front view for describing a mounted state of a virtual image display device of a first embodiment.

FIG. 2 is a conceptual perspective view for describing a configuration of the virtual image display device.

FIG. 3 is a conceptual side cross-sectional view for describing a configuration of a display optical system.

FIG. 4 is a rear view for describing an image display panel.

FIG. 5 is a rear view for describing a pattern polarizing element.

FIG. 6 is a diagram for describing a function of a polarizing diffractive lens.

FIG. 7 is a diagram for describing a state of light at a display optical system.

FIG. 8 is a conceptual side cross-sectional view for describing a virtual image display device of a second embodiment.

FIG. 9 is a conceptual side cross-sectional view for describing a virtual image display device of a third embodiment.

FIG. 10 is a conceptual side cross-sectional view for describing a virtual image display device of a fourth embodiment.

FIG. 11 is a conceptual perspective view for describing a structure of a virtual image display device of a fifth embodiment.

FIG. 12 is a conceptual side cross-sectional view for describing a configuration of the display optical system in FIG. 11.

FIG. 13 is a diagram for describing a state of light at the display optical system in FIG. 11.

FIG. 14 is a flowchart for describing operations of the virtual image display device in FIG. 11.

FIG. 15 is a side cross-sectional view for describing a configuration of a display optical system in a virtual image display device of a sixth embodiment and a state of light.

FIG. 16 is a flowchart for describing operations of the virtual image display device in FIG. 15.

### DESCRIPTION OF EMBODIMENTS

### First Embodiment

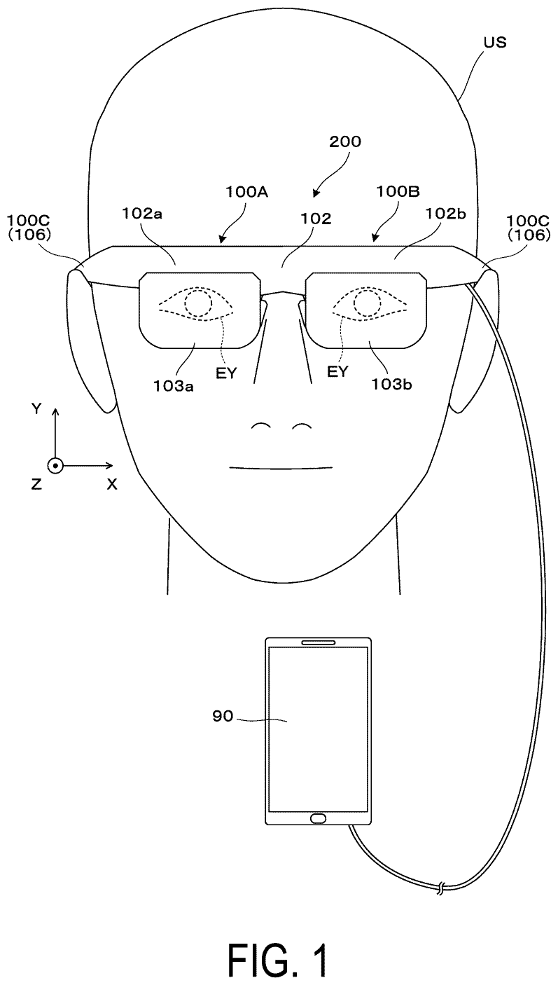

With reference to FIGS. 1 to 7, a virtual image display device of a first embodiment of the present disclosure will be described below.

FIG. 1 is a front view for describing a mounted state of a head-mounted display, in other words, a head-mounted display apparatus 200. The head-mounted display apparatus (hereinafter, also referred to as an HMD) 200 allows an observer or a wearer US who wears the HMD 200 to recognize a video as a virtual image. In FIG. 1 and the like, X, Y, and Z represent a rectangular coordinate system. The +X direction corresponds to a lateral direction in which both eyes EY of the observer or the wearer US, who wears the HMD 200, are arranged. The +Y direction corresponds to the upper direction perpendicular to the lateral direction from the viewpoint of the wearer US in which both of the eyes EY are arranged. The +Z direction corresponds to the forward direction or the front side direction from the viewpoint of the wearer US. The +Y direction is parallel to the vertical axis or the vertical direction.

The HMD 200 includes a first virtual image display device 100A for a right eye, a second virtual image display device 100B for a left eye, a pair of temples 100C that support the virtual image display devices 100A and 100B, and a user terminal 90 being an information terminal. The first virtual image display device 100A includes a first display driving unit 102a disposed at an upper portion, and a first display optical system 103a covering in front of the eye. The second virtual image display device 100B includes a second display driving unit 102b disposed at an upper portion, and a second display optical system 103b covering in front of the eye. The HMD 200 obtained by combining the first virtual image display device 100A and the second virtual image display device 100B together is also a virtual image display device in a broader sense. The pair of temples 100C function as a mounting member or a support device 106 that is worn on the head of the wearer US, and support upper end sides of the pair of display optical systems 103a and 103b via the display driving units 102a and 102b integrated in exterior. A combination of the pair of display driving units 102a and 102b is referred to as a driving device 102.

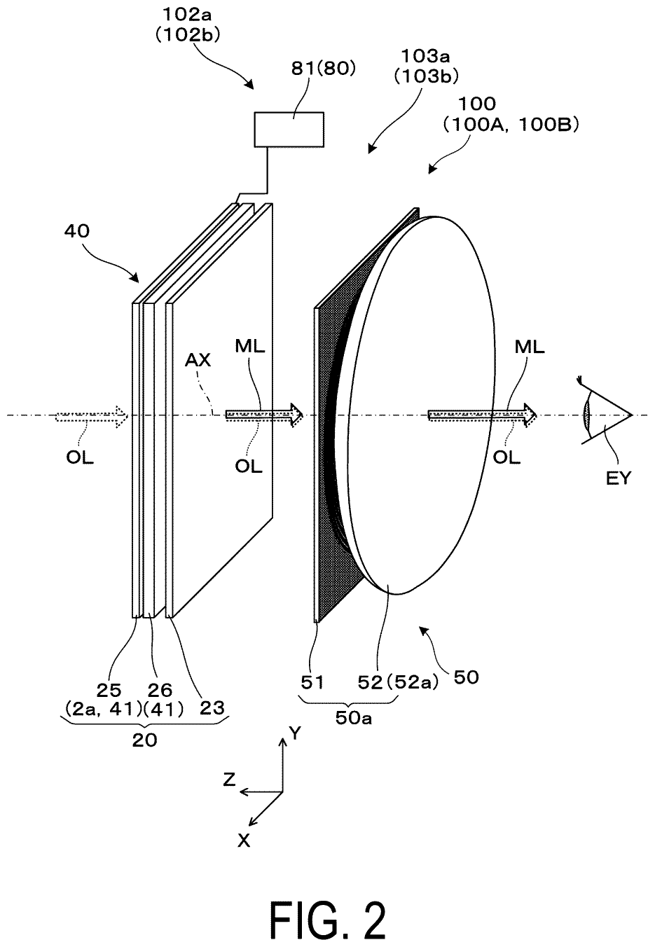

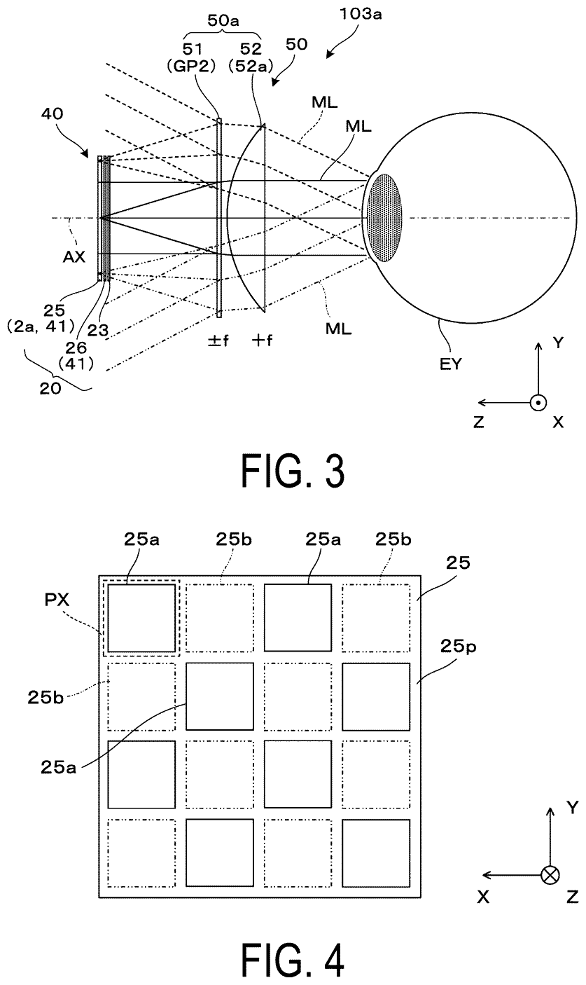

FIG. 2 is a conceptual perspective view for describing a structure of the first display optical system 103a of the first virtual image display device 100A. FIG. 3 is a conceptual side cross-sectional view for describing a configuration of the first display optical system 103a. The first display optical system 103a includes a display 40 that has a plate shape, that forms a two-dimensional image and that emits video light ML corresponding to the two-dimensional image, and an imaging system 50 that functions as a lens for the video light ML emitted from the display 40 and that forms a virtual image.

The display 40 emits the video light ML and transmits external light OL. The display device 40 includes a composite display member 20 that forms and emits the video light ML. The composite display member 20 is a plate-like member extending along an XY plane perpendicular to an optical axis AX, and includes, in order from the outside, an image display panel 25, a pattern polarizing element 26, and a quarter wavelength plate 23. The composite display member 20 has a structure in which the image display panel 25, the pattern polarizing element 26, and the quarter wavelength plate 23 are layered, and integrated by a frame body (not illustrated). In the present embodiment, the image display panel 25 and the pattern polarizing element 26 function as a polarization separation member 41 that causes the video light ML and the external light OL to have different polarization components.

The display 40 operates by being driven by a driving circuit 81 of a control device 80 incorporated in the first display driving unit 102a or the driving device 102. The composite display member 20 of the display 40 is disposed close to the eye EY with the imaging system 50 interposed therebetween, and enables observation of a virtual image by the video light ML and see-through vision of the outside. In the first display optical system 103a, a distance between the eye EY and the imaging system 50 in the optical axis AX direction is, for example, about 10 mm to 20 mm. Additionally, a distance between the image display panel 25 of the display 40 and the imaging system 50 in the optical axis AX direction is, for example, about 5 mm to 25 mm.

The image display panel 25 is a self-luminous image light generating device, and emits the video light ML with a color of red, green, or blue. The image display panel 25 is an imager 2a that forms a still image or a moving image on a two-dimensional display surface parallel to the XY plane. The image display panel 25 is driven by the driving circuit 81 to perform a display operation.

The image display panel 25 is, for example, a transmissive organic light-emitting diode (OLED) display, but may be a micro-light-emitting diode (μLED) display formed of an inorganic material or another transmissive self-luminous display device. Note that instead of the image display panel 25, a projection optical system may be used to project the video light ML onto a transparent screen.

FIG. 4 is a rear view for describing the image display panel 25. The image display panel 25 includes, on a flat plate 25p having optical transparency, a light emitting region 25a that forms the video light ML and a transmissive region 25b that transmits the external light OL. At the flat plate 25p, a plurality of light emitting regions 25a and transmissive regions 25b are arrayed in a matrix along the XY plane. One light emitting region 25a corresponds to a pixel PX, and sub-pixels of three colors of RGB are arrayed thereat.

Note that a polarizing plate (not illustrated) for limiting second polarized light P2 similar to a second polarizing element 26b of the pattern polarizing element 26 may be desirably disposed on the external side of the image display panel 25. Accordingly, the external light OL does not pass through the light emitting region 25a of the image display panel 25 when the image display panel 25 does not emit light. Note that instead of the polarizing plate, a light shielding member may be disposed at a position corresponding to the light emitting region 25a on the external side of the image display panel 25 such that the external light OL does not pass through the light emitting region 25a of the image display panel 25.

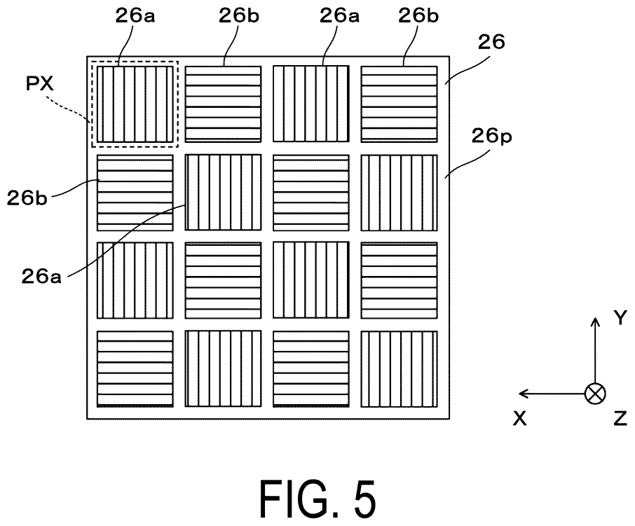

FIG. 5 is a rear view for describing the pattern polarizing element 26. The pattern polarizing element 26 has a pattern obtained by combining two types of polarizing elements together, and limits the video light ML and the external light OL in a first polarization direction and a second polarization direction, respectively. By passing through the pattern polarizing element 26, the polarization direction of the video light ML and the polarization direction of the external light OL become different from each other. At the pattern polarizing element 26, a plurality of first polarizing elements 26a and second polarizing elements 26b are arrayed in a matrix along the XY plane at a flat plate 26p having optical transparency. The first polarizing element 26a is disposed at a position corresponding to the light emitting region 25a of the image display panel 25. The second polarizing element 26b is disposed at a position corresponding to the transmissive region 25b of the image display panel 25. The first polarizing element 26a limits the video light ML to first polarized light P1 in the first polarization direction, to be more specific, to longitudinally polarized light or vertically polarized light. The second polarizing element 26b limits the external light OL to second polarized light P2 in the second polarization direction orthogonal to the first polarization direction, to be more specific, transversely polarized light or horizontally polarized light. Each of the first polarizing element 26a and the second polarizing element 26b is, for example, a wire grid type polarizing element, and has polarization characteristics corresponding to a pattern direction of a fine metal grid formed of aluminum or the like.

Note that the pattern polarizing element 26 may be a unit including, instead of the flat plate 26p, a polarizer that transmits only uniformly polarized light as a whole (a polarizer constituted by a wire grid, an absorption type TAC film, or the like) and a pattern wavelength plate patterned to have fast axes in different directions depending on the pixels of the image display panel 25.

The quarter wavelength plate 23 illustrated in FIG. 2 and the like has a principal axis in the middle between the X direction and the Y direction, for example, and converts the video light ML and the external light OL from linearly polarized light to circularly polarized light. Here, the fact that the video light ML is circularly polarized means that when attention is paid to the vibration of an electric field component or a magnetic field component of the video light ML, the vibration direction rotates at the frequency of the video light ML in a plane perpendicular to the traveling direction of the light, and the amplitude is constant regardless of the direction. The right-handed circularly polarized light is light in which the vibration direction of the electric field component rotates clockwise when viewed from an observer standing in the direction in which a light beam travels, and the left-handed circularly polarized light is light in which the vibration direction rotates counterclockwise. However, in the present specification, as long as the video light ML mainly includes the right-handed circularly polarized light, for example, even when linearly polarized light in a specific direction is included, such video light ML is assumed to be right-handed circularly polarized light RCP. Similarly, as long as the video light ML mainly includes the left-handed circularly polarized light, such video light ML is assumed to be left-handed circularly polarized light LCP. In the present, the right-handed circularly polarized light RCP is also referred to as right-circularly polarized light RCP, and the left-handed circularly polarized light LCP is also referred to as left-circularly polarized light LCP. The quarter wavelength plate 23 may be manufactured by applying a photo-crosslinkable polymer liquid crystal material on a transparent resin base material to form a thin film and fixing an alignment state, or may be manufactured by processing a birefringent crystal material such as quartz crystal into a thin plate.

The imaging system 50 is disposed on a face side, that is, the -Z side relative to the display 40 or the composite display member 20 and covers in front of the eyes. The imaging system 50 functions as a positive lens or a collimator having a positive power with respect to the video light ML.

The imaging system 50 includes a polarization-selective lens 50a. The polarization-selective lens 50a is an optical element that acts differently depending on polarized light. The polarization-selective lens 50a has a refractive power that selectively acts on polarized light of the video light ML. In other words, the polarization-selective lens 50a functions as a lens for the video light ML emitted from the display 40. That is, the polarization-selective lens 50a comprehensively images a plurality of pixels constituting the image display panel 25, and enables a video formed on the image display panel 25 to be observed as a virtual image. On the other hand, the polarization-selective lens 50a functions as a parallel flat plate with respect to the external light OL passing through the display 40. That is, the external light OL is observed as a direct-view image by passing through the display 40 so as to travel straight.

The polarization-selective lens 50a includes a polarizing diffractive lens 51 and an auxiliary lens 52 in order from the outside or the display 40 side. The polarizing diffractive lens 51 is a plate-like member that extends along the XY plane. The auxiliary lens 52 has a refractive power equivalent to that of the polarizing diffractive lens 51. Here, the term “equivalent” means that the absolute value of the refractive power of the auxiliary lens 52 and the absolute value of the refractive power of the polarizing diffractive lens 51 are the same or substantially the same. The polarizing diffractive lens 51 and the auxiliary lens 52 are disposed close to each other in parallel with each other.

The polarizing diffractive lens 51 alone functions as a positive lens, when predetermined circularly polarized light is incident thereon. The polarizing diffractive lens 51 alone functions as a negative lens, when circularly polarized light opposite to the predetermined circularly polarized light is incident thereon. The polarizing diffractive lens 51 includes a liquid crystal layer in which the larger distances from the optical axis AX are, the larger the rotation angles of the orientation axes of liquid crystal molecules are such that an initial geometric phase is formed, and this is periodically repeated. The direction in which the rotation angles of the orientation axes of the liquid crystal molecules in the polarizing diffractive lens 51 become larger has polarization dependency. The polarizing diffractive lens 51 is also referred to as a liquid crystal diffractive lens, a geometric-phase (GP) lens, an anisotropic diffractive optical element (two-dimensional anisotropic diffractive optical element), or a geometric phase lens. As described above, the auxiliary lens 52 is a lens having a refractive power equivalent to that of the polarizing diffractive lens 51, that is, a positive refractive power. The auxiliary lens 52 assists the refractive power of the polarization-selective lens 50a as a whole by being combined with the polarizing diffractive lens 51 whose refractive power differs in that the refractive power is positive or negative depending on the polarized light. As a result, the polarization-selective lens 50a functions as a positive lens for the video light ML, and functions as a parallel flat glass by canceling out powers of the polarizing diffractive lens 51 and the auxiliary lens 52 for the external light OL.

The focal length of the polarizing diffractive lens 51 is ±f. The focal length of the auxiliary lens 52 is ±f. By combining the polarizing diffractive lens 51 and the auxiliary lens 52, it is possible to implement a lens that acts as a lens having a short focal length for light in one polarization direction and that transmits light in the other polarization direction.

In the present embodiment, the auxiliary lens 52 is a refractive lens 52a. The refractive lens 52a is, for example, a convex lens, a Fresnel lens, or the like.

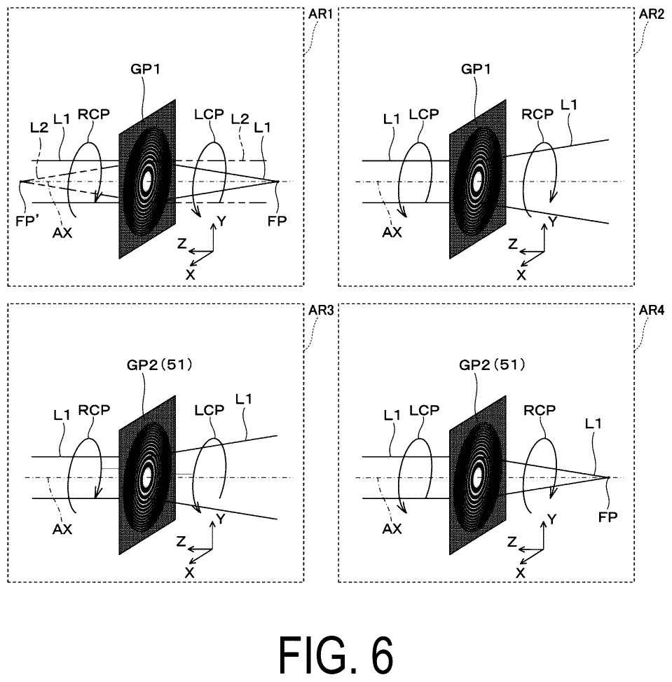

FIG. 6 is a diagram for describing a function of the polarizing diffractive lens 51. In FIG. 6, a first region AR1 indicates a first operation example of a first type polarizing diffractive lens GP1, and a second region AR2 indicates a second operation example of the first type polarizing diffractive lens GP1. In FIG. 6, a third region AR3 indicates a first operation example of a second type polarizing diffractive lens GP2, and a fourth region AR4 indicates a second operation example of the second type polarizing diffractive lens GP2. The polarizing diffractive lens 51 illustrated in FIG. 2 and the like is the second type polarizing diffractive lens GP2.

The polarizing diffractive lens GP1 has a function of converting the right-handed circularly polarized light RCP into the left-handed circularly polarized light LCP that is first circularly polarized light and converging the converted circularly polarized light to focus the converted circularly polarized light at a focal point FP when the right-handed circularly polarized light RCP that is collimated second circularly polarized light such as a light beam L1 indicated by the solid line is incident from the left side of the drawing, and has a function of converting the left-handed circularly polarized light LCP into the right-handed circularly polarized light RCP and diverging the converted right-handed circularly polarized light RCP when the collimated left-handed circularly polarized light LCP such as the light beam L1 indicated by the solid line is incident from the left side of the drawing. Note that when the right-handed circularly polarized light RCP diverging from a focal point FP′ on the left side of the drawing such as a light beam L2 indicated by the two dot chain line is incident on the polarizing diffractive lens GP1, the polarizing diffractive lens GP1 has a function converting the right-handed circularly polarized light RCP into the left-handed circularly polarized light LCP and collimating the converted circularly polarized light. That is, the polarizing diffractive lens GP1 functions as a positive lens having a predetermined focal length with respect to the right-handed circularly polarized light RCP, and inverts the rotation direction of polarized light. In addition, the polarizing diffractive lens GP1 functions as a negative lens having a focal length with the same absolute value with respect to the left-handed circularly polarized light LCP and inverts the rotation direction of polarized light. In other words, the polarizing diffractive lens GP1 is an optical element having a positive power with respect to the right-handed circularly polarized light RCP and a negative power with respect to the left-handed circularly polarized light LCP.

The polarizing diffractive lens GP2 has a function of converting the right-handed circularly polarized light RCP into the left-handed circularly polarized light LCP that is first circularly polarized light and diverging the converted circularly polarized light when the right-handed circularly polarized light RCP that is collimated second circularly polarized light such as a light beam L1 indicated by the solid line is incident from the left side of the drawing. The polarizing diffractive lens GP2 has a function of converting the left-handed circularly polarized light LCP into the right-handed circularly polarized light RCP and converging the converted circularly polarized light to focus the converted circularly polarized light at a focal point FP when the collimated left-handed circularly polarized light LCP such as a light beam L1 indicated by the solid line is incident from the left side of the drawing. That is, the polarizing diffractive lens GP2 inverts the rotation direction of the polarized light while functioning as a positive lens having a predetermined focal length with respect to the left-handed circularly polarized light LCP. In addition, the polarizing diffractive lens GP2 inverts the rotation direction of the polarized light while functioning as a negative lens having a focal length with the same absolute value with respect to the right-handed circularly polarized light RCP. That is, the polarizing diffractive lens GP2 is an optical element having a negative power with respect to the right-handed circularly polarized light RCP and a positive power with respect to the left-handed circularly polarized light LCP.

Each of the polarizing diffractive lenses GP1 and GP2 is formed with a distribution of refractive index anisotropy grasped by a large number of annular zones with the optical axis AX as a center in a plane, and functions as a diffractive lens according to the distribution of refractive index anisotropy and the polarized state of incident light. To be more specific, when each of the polarizing diffractive lenses GP1 and GP2 has a distribution of refractive index anisotropy in which the orientations of the optical axes are rotated (actually repeatedly rotated within a range of 0 to π) as the distances from the optical axis AX increase in two directions orthogonal to each other and orthogonal to the optical axis AX as the center, a geometric phase is formed on specific circularly polarized light incident on the polarizing diffractive lens. In addition, circularly polarized light is diffracted and the polarized state is inverted at a diffraction angle that reflects a cycle length of the rotation of the optical axis in each orientation. The polarizing diffractive lens, as a whole, causes specific circularly polarized light to be diffracted corresponding to a power formed by the lens shape, and inverts the state of the circularly polarized light, for example, from right-handed circularly polarized light to left-handed circularly polarized light before and after the circularly polarized light passes through the lens.

Although not illustrated, each of the polarizing diffractive lens GP1 and the polarizing diffractive lens GP2 is obtained by forming a liquid crystal-containing material layer as a thin film on a transparent substrate, and has a thin plate shape as a whole. The liquid crystal-containing material layer contains a predetermined liquid crystal material, and orientation axes of liquid crystal molecules are aligned in parallel to, for example, the X direction in a region near the optical axis AX so as to form an initial geometric phase, and gradually rotate in the XY plane as the orientation axes are farther away from the optical axis AX, that is, according to distances or radii around the optical axis AX. That is, the rotation angles of the orientation axes of the liquid crystal molecules increase according to the distances from the optical axis AX, and this is periodically repeated. In a liquid crystal compound layer, in the Z direction parallel to the optical axis AX, for example, the orientation axes of the liquid crystal molecules are arrayed while being kept constant. Note that directions in which the rotation angles of the orientation axes of the liquid crystal molecules are increased are reversed between the polarizing diffractive lens GP1 and the polarizing diffractive lens GP2. A method for manufacturing the polarizing diffractive lens GP1 or the polarizing diffractive lens GP2 includes, for example, applying, on a substrate, a liquid crystal-containing material film in which a liquid crystal material and an ultraviolet-curable organic material layer are mixed, two-dimensionally scanning the liquid crystal-containing material film with UV laser light in a predetermined polarized state, and then curing the organic material layer while adjusting the orientation axes of the liquid crystal molecules. Thereby, the orientation axes of the liquid crystal molecules can be three-dimensionally controlled and fixed in the liquid crystal-containing material layer, and the liquid crystal compound layer in which the rotation angles of the orientation axes increase as the distances increase from the optical axis AX as described above is obtained. Such a polarizing diffractive lens GP1 itself is a known technique (see, for example, the document written by Kohei Noda, et al. Applied Optics, Feb. 10, 2017, Vol.56, No. 5:1302), for example, as a polarization-dependent liquid crystal Fresnel lens.

The polarizing diffractive lenses GP1 and GP2 can also be produced by a method for manufacturing a liquid crystal optical body described in JP-T-2008-501147.

The polarizing diffractive lens GP1 and the polarizing diffractive lens GP2 do not need to be different from each other, and when the polarizing diffractive lens GP1 is rotated by 180° around the Y-axis and its front and rear are inverted, the polarizing diffractive lens GP2 is obtained. In other words, each of the polarizing diffractive lenses GP1 and GP2 can be made to function as both a positive lens and a negative lens with respect to the same circularly polarized light by reversing the front and the rear thereof. This is because, in the polarizing diffractive lenses GP1 and GP2, since the orientation axes of the liquid crystal molecules are increased so as to rotate in a specific direction according to the distances from the optical axis AX as the center as described above, the rotation directions with respect to the absolute values of the distances coincide with each other in, for example, ±X directions perpendicular to the optical axis AX, and the rotation directions of the orientation axes are inversed when the polarizing diffractive lenses GP1 and GP2 are viewed from the rear side.

The focal length of the polarizing diffractive lens GP1 and the focal length of the polarizing diffractive lens GP2 can be increased or decreased depending on a manufacturing method and a liquid crystal material. In the liquid crystal compound layer, the absolute value of the positive or negative power of the polarizing diffractive lenses GP1 and GP2 can be increased by increasing the increase rate of the rotation angles with respect to the distances or radii from the optical axis AX when the rotation angles of the orientation axes of the liquid crystal molecules are increased as the distances from the optical axis AX increase, that is, by decreasing the rotation cycle length of the orientation axes, enabling adjustment of the focal lengths. When circularly polarized light passes through each of the polarizing diffractive lenses GP1 and GP2, a loss of the light beam L1 as the circularly polarized light is close to 0, and each of the polarizing diffractive lenses GP1 and GP2 exhibits a transmittance of almost 100%.

When linearly polarized light is incident on the polarizing diffractive lens GP1, right-handed circularly polarized light RCP and left-handed circularly polarized light LCP included in the linearly polarized light behave in different ways. The components of the right-handed circularly polarized light RCP are converged through the polarizing diffractive lens GP1, and the components of the left-handed circularly polarized light LCP are diverged through the polarizing diffractive lens GP1, and the rotation directions of the respective polarized lights are inversed.

In the imaging system 50, the polarizing diffractive lens 51 is the polarizing diffractive lens GP2 illustrated in FIG. 6, and functions as an optical element having a positive power with respect to the video light ML when the video light ML incident from the display 40 is the left-handed circularly polarized light LCP, and inverts the rotation direction of the polarized light while reducing the divergence of the video light ML, thereby converting the video light ML into the right-handed circularly polarized light RCP. The video light ML having passed through the polarizing diffractive lens 51 is incident on the auxiliary lens 52 in a state of the right-handed circularly polarized light RCP.

When the external light OL is right-handed circularly polarized light RCP, the polarizing diffractive lens 51 functions as an optical element having a negative power with respect to the external light OL, and inverts the rotation direction of the polarized light while reducing the convergence of the external light OL, thereby converting the external light OL into left-handed circularly polarized light LCP. The external light OL having passed through the polarizing diffractive lens 51 is incident on the auxiliary lens 52 in a state of the left-handed circularly polarized light LCP.

The auxiliary lens 52 functions as an optical element having a positive power with respect to the video light ML, and reduces the divergence while maintaining the rotation direction of the polarized light as the right-handed circularly polarized light RCP. In this case, the absolute value of a power of the polarizing diffractive lens 51 and the absolute value of a power of the auxiliary lens 52 are set to be equal to each other, and the combined focal length of both the lenses 51 and 52, that is, the polarization-selective lens 50a is substantially equivalent to the combined focal length of two convex lenses disposed adjacent to each other. When the combined focal length of the polarization-selective lens 50a is equal to the distance from the intermediate point between both the lenses 51 and 52 to the display surface of the display 40, the imaging system 50 functions as a collimator, and converges the video light ML onto a pupil position PP while collimating the video light ML.

The auxiliary lens 52 functions as an optical element having a positive power with respect to the external light OL, and reduces the divergence while maintaining the rotation direction of the polarized light as the left-handed circularly polarized light LCP. In this case, both the lenses 51 and 52 are disposed close to each other and are set such that the absolute values of the powers thereof are equal to each other, and the combined focal length of both the lenses 51 and 52, that is, the polarization-selective lens 50a, is infinite. When the combined focal length of the polarization-selective lens 50a is infinite, the imaging system 50 functions equivalently to a parallel flat plate that is an optical system having a power of substantially 0, and causes the external light OL to travel substantially straight without exerting an imaging action such as light condensing on the external light OL. This achieves a state where the naked eye can observe the external light OL.

The second display optical system 103b is optically the same as the first display optical system 103a, or is obtained by inverting the first display optical system 103a horizontally. Thus, detail description thereof is omitted.

Note that an optical device obtained by excluding the control device 80 from the first virtual image display device 100A is referred to as an optical unit 100. In addition, an optical device obtained by excluding the control device 80 from the second virtual image display device 100B is referred to as an optical unit 100.

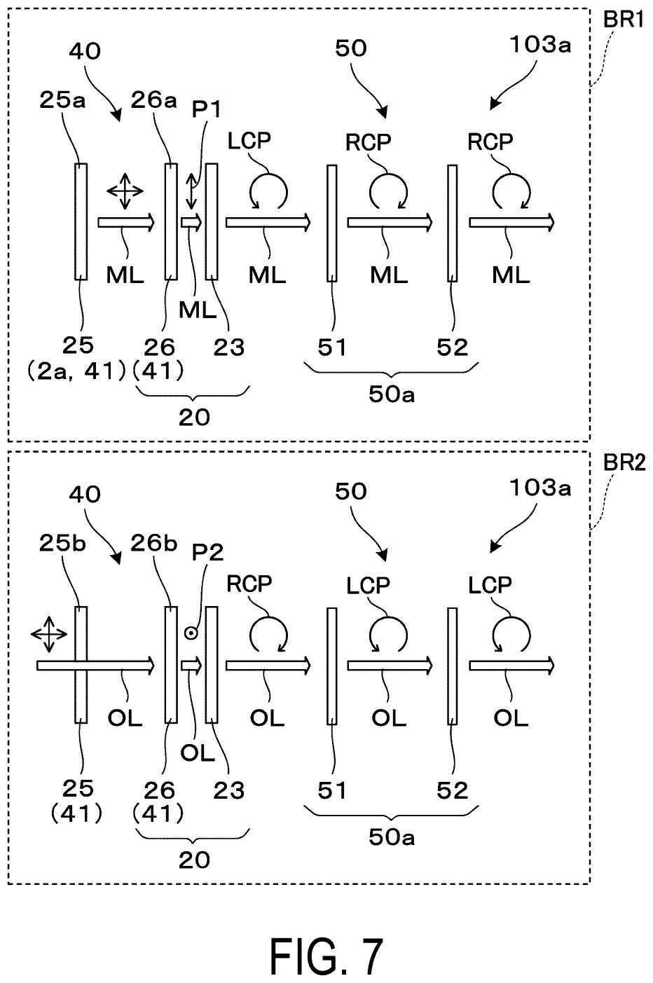

FIG. 7 is a diagram for describing a state of light in the first display optical system 103a. In FIG. 7, a first region BR1 indicates a state of the video light ML, and a second region BR2 indicates a state of the external light OL.

In observing a video, the video light ML is emitted from the light emitting region 25a of the image display panel 25. The video light ML emitted from the image display panel 25 includes the first polarized light P1 that is longitudinally polarized light and the second polarized light P2 that is transversely polarized light. The video light ML emitted from the image display panel 25 is incident on the pattern polarizing element 26. The video light ML passes through the first polarizing element 26a of the pattern polarizing element 26 and is limited to the first polarized light P1. The video light ML having passed through the pattern polarizing element 26 passes through the quarter wavelength plate 23 and is converted from the first polarized light P1 into the left-handed circularly polarized light LCP. The imaging system 50 is in a state of having a positive power with respect to the video light ML of the left-handed circularly polarized light LCP, and the video light ML can be observed.

On the other hand, in observing external light, the external light OL passes through the transmissive region 25b of the image display panel 25 and is incident on the pattern polarizing element 26. The external light OL passes through the second polarizing element 26b of the pattern polarizing element 26 and is limited to the second polarized light P2. The external light OL that has passed through the pattern polarizing element 26 passes through the quarter wavelength plate 23 and is converted from the second polarized light P2 into the right-handed circularly polarized light RCP. The imaging system 50 is in a state in which the power is substantially 0 with respect to the external light OL of the right-handed circularly polarized light RCP, and the external light OL can be observed.

The virtual image display device 100A or the display optical system 103a that performs display as described above enables see-through display in which the video light ML and the external light OL are superimposed on each other.

In the above description, the display 40 incorporating the transmissive liquid crystal panel 22 is used. However, instead of the transmissive liquid crystal panel 22, another type of imager 2a such as an organic electro-luminescence (organic EL) display may be used. However, it is desirable that the imager 2a of the organic EL display block the external light OL while an image is being displayed and transmit the external light OL while the image display is stopped. In this case, it is desirable to dispose a polarizing plate on the light emission side of the organic EL display as the imager 2a.

In the above description, the image display panel 25 has sub-pixels of three colors. However, when the chromatic aberration of the imaging system 50 is large, the imager 2a or the image display panel 25 can be constituted by only pixels of a single color.

The virtual image display device 100A, 100B or the optical unit 100 according to the first embodiment described above includes the display 40 configured to emit the video light ML and the polarization-selective lens 50a that is disposed facing the display 40 and that has a refractive power that selectively acts on polarized light of the video light ML. The polarization-selective lens 50a includes, in order from the display 40 side, the polarizing diffractive lens 51 having a positive refractive power with respect to the video light ML that is circularly polarized light and a negative refractive power with respect to the external light OL that is circularly polarized light, and the auxiliary lens 52 having a positive refractive power equivalent to a refractive power of the polarizing diffractive lens 51.

In the virtual image display device 100A, 100B, the polarizing diffractive lens 51 has a positive refractive power with respect to the video light ML that is circularly polarized light from the display 40, and the auxiliary lens 52 has a positive refractive power with respect to the video light ML that is circularly polarized light having passed through the polarizing diffractive lens 51. This enables observation of an image formed on the display surface of the display 40 by the imaging system 50 that is thin but has a short focal length even when the display 40 is disposed in front of an eye. That is, the virtual image display device 100A, 100B including the imaging system 50 can be reduced in thickness. In addition, since the polarizing diffractive lens 51 has a negative refractive power with respect to the external light OL that is circularly polarized light and the auxiliary lens 52 has a positive refractive power with respect to the external light OL that is circularly polarized light having passed through the polarizing diffractive lens 51 so as to cancel out the power of the polarizing diffractive lens 51, the external light OL can be observed.

### Second Embodiment

A virtual image display device and the like according to a second embodiment will be described below. Note that the virtual image display device according to the second embodiment is provided by partially modifying the virtual image display device according to the first embodiment. Thus, explanation of portions common to the virtual image display device according to the first embodiment will not be repeated.

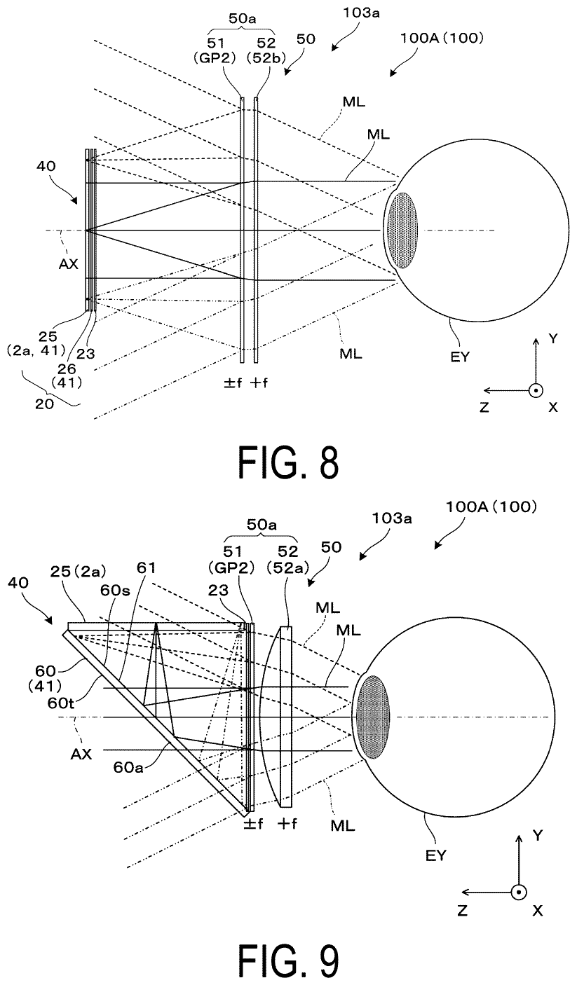

In the virtual image display device 100A or the optical unit 100 illustrated in FIG. 8, the polarization-selective lens 50a includes the polarizing diffractive lens 51 and the auxiliary lens 52. The polarizing diffractive lens 51 and the auxiliary lens 52 can be disposed in a bonded state. Since the polarization-selective lens 50a is formed by aligning the lenses 51 and 52 each of which has a thin plate shape, the imaging system 50 can be made thinner.

In the present embodiment, the auxiliary lens 52 is a diffractive lens 52b. The diffractive lens 52b has a flat plate shape, and is a kinoform phase-modulating lens that is not dependent on polarization. The diffractive lens 52b is, for example, a Fresnel zone plate, a liquid crystal lens, or the like.

### Third Embodiment

A virtual image display device and the like according to a third embodiment will be described below. Note that the virtual image display device according to the third embodiment is provided by partially modifying the virtual image display device according to the first embodiment. Thus, explanation of portions common to the virtual image display device according to the first embodiment will not be repeated.

In the virtual image display device 100A or the optical unit 100 illustrated in FIG. 9, the display 40 includes the image display panel 25, a polarization half mirror 60, and the quarter wavelength plate 23. The quarter wavelength plate 23 is disposed close to the incident side of the imaging system 50. In the present embodiment, the polarization half mirror 60 functions as the polarization separation member 41.

The polarization half mirror 60 is disposed between the image display panel 25 and the imaging system 50 so as to be able to reflect the video light ML from the image display panel 25 toward the imaging system 50. The polarization half mirror 60 reflects polarized light in a predetermined direction, and selectively reflects the video light ML from the image display panel 25 and transmits the external light OL. In the polarization half mirror 60, a polarization separation film 61 is provided on one surface 60s of a substrate 60a having optical transparency. The polarization separation film 61 reflects, for example, the first polarized light P1 of the video light ML and transmits, for example, the second polarized light P2 of the external light OL. The polarization separation film 61 is formed of a dielectric multilayer film. The polarization separation film 61 may be any film that selectively reflects the video light ML or the like according to the polarization direction, and may be formed of, for example, a wire grid polarizer. In the polarization half mirror 60, an antireflection film can be formed at the other surface 60t of the substrate 60a. The polarization half mirror 60 may be a flat surface or a curved surface.

The polarization half mirror 60 is inclined relative to the vertical direction or the Y direction that is perpendicular to the direction in which the eyes EY are aligned. The inclination angle of the polarization half mirror 60 is, for example, 45°, but does not need to be 45°.

The imaging system 50 is the polarization-selective lens 50a, and includes the polarizing diffractive lens 51 and the auxiliary lens 52. The polarizing diffractive lens GP2 illustrated in FIG. 6 is used as the polarizing diffractive lens 51. The auxiliary lens 52 may be the refractive lens 52a illustrated in FIG. 9 or the diffractive lens 52b illustrated in FIG. 8.

In the present embodiment, the pattern polarizing element 26 is not provided. Thus, in the image display panel 25, a plurality of light emitting regions 25a are arrayed in a matrix as a whole.

### Fourth Embodiment

A virtual image display device and the like according to a fourth embodiment will be described below. The virtual image display device according to the fourth embodiment is obtained by partially modifying the virtual image display device according to the first embodiment, and description of parts in common with those of the virtual image display device according to the first embodiment is omitted.

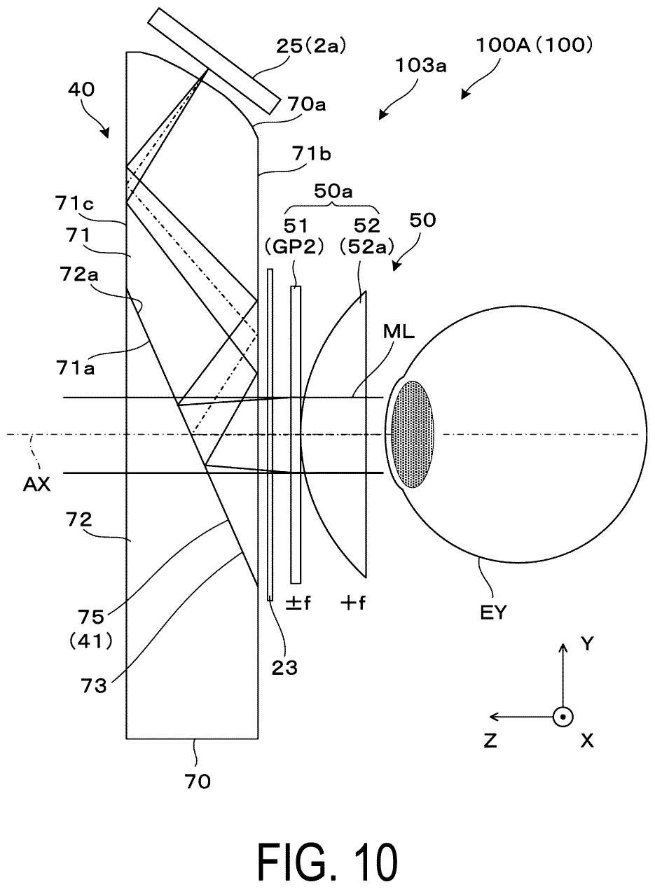

In the virtual image display device 100A or the optical unit 100 illustrated in FIG. 10, the display 40 includes the image display panel 25, a light-guiding member 70, and the quarter wavelength plate 23. The quarter wavelength plate 23 is disposed close to the incident side of the imaging system 50. In the present embodiment, a polarization half mirror 75 of the light-guiding member 70, which will be described later, functions as the polarization separation member 41.

The light-guiding member 70 is a member having a parallel plate shape as a whole, and includes a first prism 71 and a second prism 72. The first prism 71 and the second prism 72 are joined at inclined surfaces 71a and 72a. A polarization separation film 73 is formed on the inclined surface 71a of the first prism 71 and functions as the polarization half mirror 75 in the light-guiding member 70. Similarly to the polarization half mirror 60 of the third embodiment, the polarization half mirror 75 reflects polarized light in a predetermined direction, and selectively reflects the video light ML from the image display panel 25 and transmits the external light OL. The video light ML emitted from the light-guiding member 70 is, for example, the first polarized light P1. The external light OL emitted from the light-guiding member 70 is, for example, the second polarized light P2.

The first prism 71 includes a convex surface 70a as an incident surface of the video light ML at a surface facing the image display panel 25. The first prism 71 guides the video light ML incident from the image display panel 25. The first prism 71 includes an inner surface 71b and an outer surface 71c that are parallel to the quarter wavelength plate 23 disposed on the emission side. The video light ML incident on the first prism 71 is totally reflected at the outer surface 71c and the inner surface 71b, and the first polarized light P1 is reflected at the polarization half mirror 75 and is emitted from the light-guiding member 70.

The second prism 72 is disposed below the first prism 71 with the polarization separation film 73 interposed therebetween. The second prism 72 transmits the external light OL. Of the external light OL incident on the second prism 72, the second polarized light P2 passes through the polarization half mirror 75 and is emitted from the light-guiding member 70.

Each of the first prism 71 and the second prism 72 is made of resin or glass, and is formed of a material having a low birefringence. Reducing the birefringence of the light-guiding member 70 can suppress a polarization change derived from the birefringence in the light-guiding member 70. As a result, it is possible to prevent the lens action of the polarizing diffractive lens 51 of the imaging system 50 from changing in the screen and thus causing unevenness.

The imaging system 50 is the polarization-selective lens 50a, and includes the polarizing diffractive lens 51 and the auxiliary lens 52. The polarizing diffractive lens GP2 illustrated in FIG. 6 is used as the polarizing diffractive lens 51. The auxiliary lens 52 may be the refractive lens 52a illustrated in FIG. 10 or the diffractive lens 52b illustrated in FIG. 8.

In the present embodiment, the pattern polarizing element 26 is not provided. Thus, in the image display panel 25, a plurality of light emitting regions 25a are arrayed in a matrix as a whole.

### Fifth Embodiment

A virtual image display device and the like according to a fifth embodiment will be described below. The virtual image display device according to the fifth embodiment is obtained by partially modifying the virtual image display device according to the first embodiment, and description of parts in common with those of the virtual image display device according to the first embodiment is omitted.

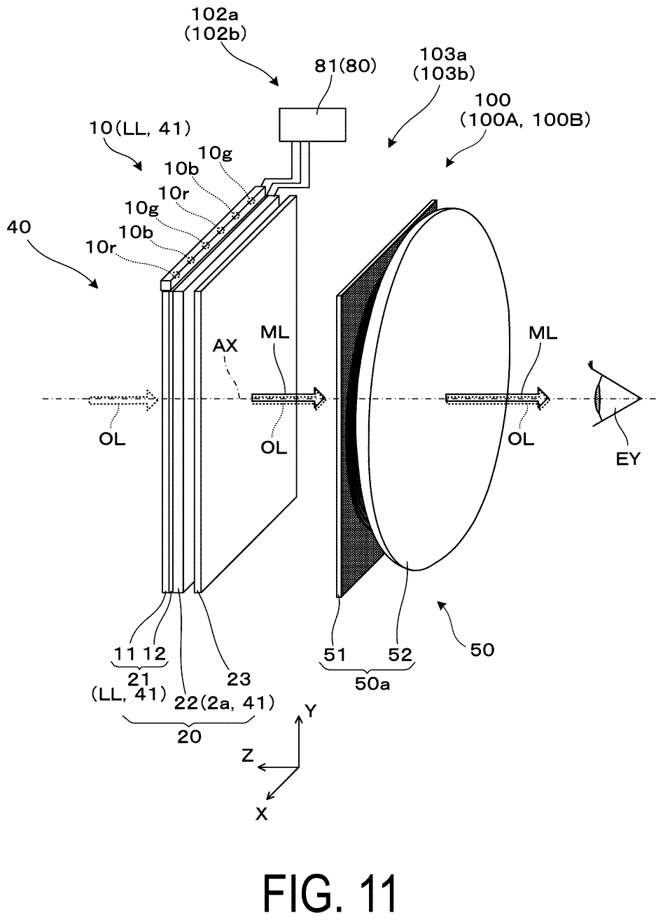

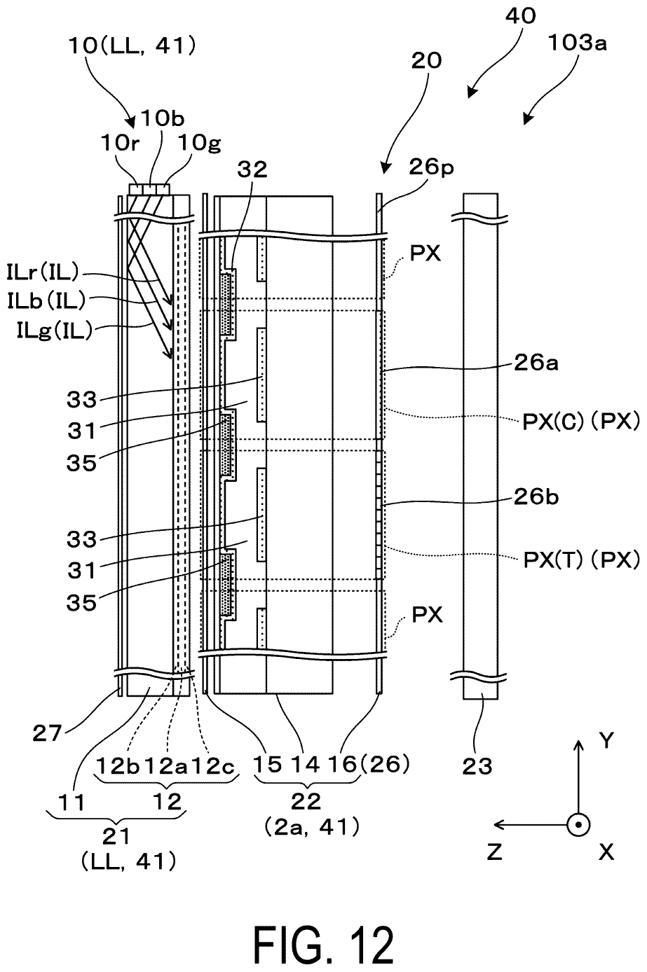

FIG. 11 is a conceptual perspective view for describing a structure of the first display optical system 103a in the first virtual image display device 100A. FIG. 12 is a side cross-sectional view for describing a structure of the display 40.

The display 40 includes a light source 10 that generates lights of three colors as illumination lights in a time division manner, and the composite display member 20 that forms and emits the video light ML. The light source 10 is a part of the first display driving unit 102a illustrated in FIG. 1, and is disposed above and near an upper side of the light-guiding member 21, which will be described later, of the composite display member 20 to supply illumination light from an upper end side to the light-guiding member 21. The composite display member 20 of the display 40 is disposed close to the eye EY with the imaging system 50 interposed therebetween, and enables observation of a virtual image by the video light ML and see-through vision of the outside. In the first display optical system 103a, a distance between the eye EY and the imaging system 50 in the optical axis AX direction is, for example, about 10 mm to 20 mm. A distance between the transmissive liquid crystal panel 22 of the display 40 and the imaging system 50 in the optical axis AX direction is, for example, about 5 mm to 25 mm.

The light source 10 includes one or a plurality of R light-emitting elements 10r that emit red light, one or a plurality of B light-emitting elements 10b that emit blue light, and one or a plurality of G light-emitting elements 10g that emit green light. The R light-emitting element 10r, the B light-emitting element 10b, and the G light-emitting element 10g may be self-luminous elements, for example, organic light-emitting diodes (OLED), but may be light-emitting diodes such as micro-light-emitting diodes (μLED) made of an inorganic material. A combiner/splitter including a beam splitter can be incorporated between the light source 10 and the light-guiding member 21 of the composite display member 20 to assist diffusion of the illumination light.

The composite display member 20 is a plate-like member extending along an XY plane perpendicular to the optical axis AX, and includes the light-guiding member 21, the transmissive liquid crystal panel 22, and the quarter wavelength plate 23 in order from the outside. The composite display member 20 has a structure in which the light-guiding member 21, the transmissive liquid crystal panel 22, and the quarter wavelength plate 23 are layered, and integrated by a frame body (not illustrated). Here, the light-guiding member 21 and the transmissive liquid crystal panel 22 are disposed close to each other at a predetermined interval or less. The transmissive liquid crystal panel 22 is the imager 2a that forms the video light ML. Note that the transmissive liquid crystal panel 22 includes a plurality of pixels PX (see FIG. 12) arrayed in a matrix along the XY plane.

It should be noted that a polarizing plate 27 (see FIG. 12) that limits polarized light of the external light OL is provided on the external side of the light-guiding member 21.

The light source 10 and the light-guiding member 21 function as a backlight LL. In the present embodiment, the backlight LL and the transmissive liquid crystal panel 22 (including a pattern polarizing element 26, which will be described later) function as the polarization separation member 41 that causes the video light ML and the external light OL to have different polarization components.

The imaging system 50 is disposed on a face side, that is, the-Z side relative to the display 40 or the composite display member 20 and covers in front of the eyes. The imaging system 50 includes the polarization-selective lens 50a. The polarization-selective lens 50a includes the polarizing diffractive lens 51 and the auxiliary lens 52 in order from the outside or the display 40 side.

Referring to FIG. 12, the light source 10 emits illumination light ILr, illumination light ILg, and illumination light ILb of three colors from light-emitting elements 10r, 10g, and 10b as illumination light IL, and supplies the illumination light ILr, the illumination light ILg, and the illumination light ILb of the three colors to the light-guiding member 21 of the composite display member 20.

The light-guiding member 21 is obtained by fixing a ferroelectric liquid crystal plate 12 to a light-guiding plate 11. The illumination light ILr, the illumination light ILg and the illumination light ILb from the light source 10 are coupled into the light-guiding plate 11 from an upper end of the light-guiding plate 11. The light-guiding plate 11 propagates the illumination light ILr, the illumination light ILg, and the illumination light ILb that have been incident from the light source 10 downward.

The ferroelectric liquid crystal plate 12 is a device that performs a switch-type operation in response to a driving signal from the driving circuit 81, and can be switched between a scattering state (on state) in which the illumination light IL (ILr, ILg, ILb) is emitted to the outside of the light-guiding plate 11 and a transparent state (off state) in which the external light OL is transmitted and permitted to pass. The ferroelectric liquid crystal plate 12 includes a ferroelectric liquid crystal layer 12a sandwiched between a pair of base materials 12b and 12c with transparent electrode layers (not illustrated) interposed therebetween. The ferroelectric liquid crystal layer 12a is, for example, a reverse mode polymer dispersed liquid crystal, and is in a transmissive state when no electric field is applied and is in a scattering state when an electric field is applied (see, for example, JP-A-6-308543). The ferroelectric liquid crystal plate 12 can be switched on and off not for each pixel PX but for the entire surface. Note that the ferroelectric liquid crystal layer 12a may be in a transmissive state when an electric field is applied and may be in a scattering state when no electric field is applied.

Note that instead of the ferroelectric liquid crystal plate 12, a scattering member that scatters the video light ML may be provided at the light-guiding plate 11.

The transmissive liquid crystal panel 22 includes a liquid crystal modulation member 14 and a pair of polarizing plates 15 and 16 that sandwich the liquid crystal modulation member 14. In this case, the transmissive liquid crystal panel 22 is a modulation element formed of, for example, in-plane switching (IPS) liquid crystal, and includes video light generating pixels PX (C) and external light transmitting pixels PX(T). The video light generating pixels PX(C) and the external light transmitting pixels PX(T) are alternately arrayed. The liquid crystal modulation member 14 does not rotate the polarization direction of incident light when no electric field is applied and rotates the polarization direction of incident light when an electric field is applied. In this case, the pair of polarizing plates 15 and 16 are an absorptive polarizing element. The polarizing plate 16 is similar to the pattern polarizing element 26 illustrated in FIG. 5.

The transmissive liquid crystal panel 22 can switch between an on state and an off state for each pixel PX in response to a driving signal from the driving circuit 81, and can partially transmit incident light at a freely-selected intermediate gradation between the on state and the off state. For this reason, the liquid crystal modulation member 14 includes not only a liquid crystal layer 31, a common electrode 32, a pixel electrode 33, and a black matrix 35 but also scanning lines, signal lines, switch elements, and the like, which are not illustrated.

Note that the transmissive liquid crystal panel 22 or the liquid crystal modulation member 14 may operate so as to rotate the polarization direction of incident light when no electric field is applied, and so as not to rotate the polarization direction of incident light when an electric field is applied.

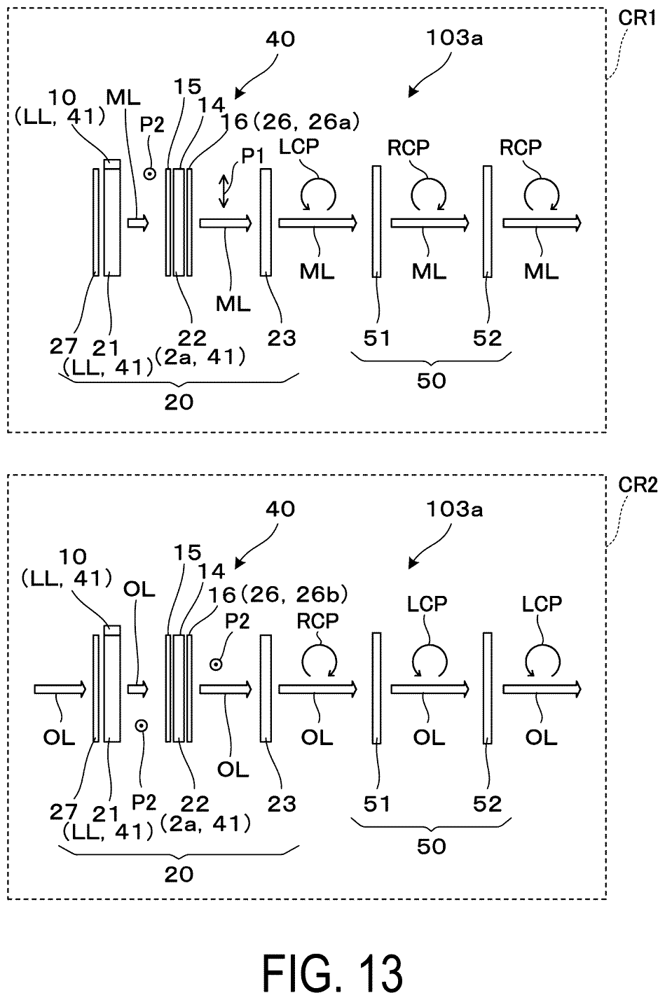

FIG. 13 is a diagram for describing a state of light at the display 40. In FIG. 13, a first region CR1 indicates a case where the first display optical system 103a is in a video observation period and the display 40 is in a display state. A second region CR2 indicates a case where the first display optical system 103a is in an external light observation period and the display 40 is in a non-display state.

When the display 40 is in the display state in the video observation period, the light-emitting elements 10r, 10g, and 10b of the light source 10 emit light, and the illumination light ILr, the illumination light ILg, and the illumination light ILb are supplied to the light-guiding member 21. At this timing, when the ferroelectric liquid crystal plate 12 is switched to the on state that is a first state and comes to be in the scattering state, the illumination light ILr, the illumination light ILg, and the illumination light ILb illuminate the liquid crystal modulation member 14 as the second polarized light P2 that is transversely polarized light or horizontally polarized light through the first polarizing plate 15 of the transmissive liquid crystal panel 22. That is, the video light generating pixel PX(C) constituting the transmissive liquid crystal panel 22 is illuminated. Video light ML(R), video light ML(G), and video light ML(B) having passed through the liquid crystal modulation member 14 are obtained by rotating the polarization planes of the illumination light ILr, the illumination light ILg, and the illumination light ILb in response to the driving signal, and only the first polarized light P1 that is longitudinally polarized light or vertically polarized light is emitted through a second polarizing plate 16. The video light ML(R), the video light ML(G), and the video light ML(B) emitted from the video light generating pixel PX(C) of the transmissive liquid crystal panel 22 passes through the quarter wavelength plate 23 and is converted from the first polarized light P1 into the left-handed circularly polarized light LCP.

On the other hand, when the display 40 is in a non-display state in the external light observation period, the light source 10 is set to a non-emission state, that is, a turn-off state, and the supply of the illumination light IL to the light-guiding member 21 is stopped. At this timing, when the ferroelectric liquid crystal plate 12 is switched to the off state that is a second state and comes to be in the transmissive state, the external light OL travels straight so as to intersect the light-guiding member 21 and is incident on the transmissive liquid crystal panel 22. At this time, the external light transmitting pixel PX(T) of the transmissive liquid crystal panel 22 operates, for example, in a normally-off state and is set to a maximally transmissive state by a driving signal, and the second polarized light P2 of the external light OL incident on the external light transmitting pixel PX(T) of the transmissive liquid crystal panel 22 travels straight through the transmissive liquid crystal panel 22, that is, the external light transmitting pixel PX(T) and is emitted. The external light OL emitted from the external light transmitting pixel PX(T) of the transmissive liquid crystal panel 22 passes through the quarter wavelength plate 23 and is converted from the second polarized light P2 into the right-handed circularly polarized light RCP.

In the video observation period, the imaging system 50 is in a state of having a positive power, enabling observation of the video light ML. In addition, in the external light observation period, the imaging system 50 is in a state of having a power of substantially 0, enabling observation of the external light OL.

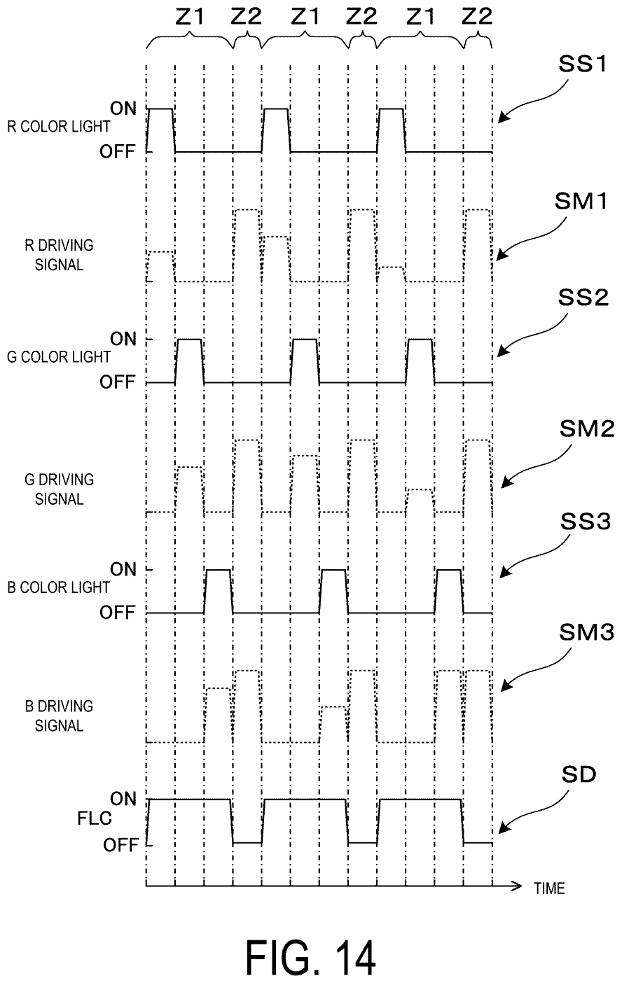

FIG. 14 is a timing chart for describing the display operation of the display optical system 103a. The horizontal axis represents time, and indicates, in order from the above, a blinking signal SS1 of the R light-emitting element 10r, an R driving signal SM1 for red display given to the liquid crystal modulation member 14, a blinking signal SS2 of the G light-emitting element 10g, a G driving signal SM2 for green display given to the liquid crystal modulation member 14, a blinking signal SS3 of the B light-emitting element 10b, a B driving signal SM3 for blue display given to the liquid crystal modulation member 14, and an on/off signal SD of the ferroelectric liquid crystal plate (FLC) 12. The operation of the first virtual image display device 100A includes a first sub-frame Z1 that is a sub-frame for video observation and a second sub-frame Z2 that is a sub-frame for external light observation in each frame.

In this case, when the first virtual image display device 100A is in the video observation period and the transmissive liquid crystal panel 22 is in the display state, the three colors of the video light ML(R), the video light ML(G), and the video light ML(B) are displayed in a time division manner, and when the first virtual image display device 100A is in the external light observation period and the transmissive liquid crystal panel 22 is in the non-display state, the external light OL passes through the external light transmitting pixel PX (T) of the transmissive liquid crystal panel 22.

### Sixth Embodiment

A virtual image display device and the like according to a sixth embodiment will be described below. The virtual image display device according to the sixth embodiment is obtained by partially modifying the virtual image display device according to the first and fifth embodiments, and description of parts in common with those of the virtual image display device according to the first embodiment or the like is omitted.

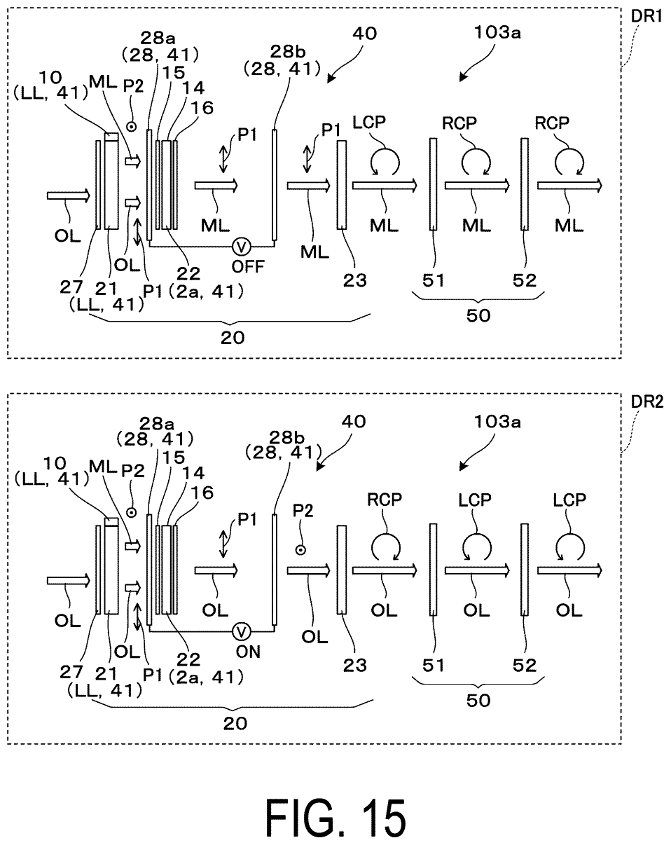

FIG. 15 is a conceptual side cross-sectional view for describing a structure of the first display optical system 103a and a state of light. In FIG. 15, a first region DR1 indicates a case where the first display optical system 103a is in a video observation period and the display 40 is in a display state. A second region DR2 indicates a case where the first display optical system 103a is in an external light observation period and the display 40 is in a non-display state.

The display 40 includes the light source 10 that generates lights of three colors as illumination lights in a time division manner, and the composite display member 20 that forms and emits the video light ML.

The composite display member 20 includes the light-guiding member 21, the transmissive liquid crystal panel 22, and the quarter wavelength plate 23 in order from the outside. Moreover, the composite display member 20 also includes a time-division half wavelength plate 28 in which the transmissive liquid crystal panel 22 is interposed between a pair of liquid crystal wavelength plates 28a and 28b. The transmissive liquid crystal panel 22 is the imager 2a that forms the video light ML. The second polarizing plate 16 on the emission side constituting the transmissive liquid crystal panel 22 of the present embodiment is not the pattern polarizing element 26 illustrated in FIG. 5, but limits the light passing therethrough to a specific polarized light, for example, the first polarized light P1.

In the present embodiment, the pixel PX of the transmissive liquid crystal panel 22 is not limited to a pixel constituted for each color, and may be constituted by sub-pixels of three colors of RGB and a sub-pixel for transmitting the external light OL. In this case, a color filter is provided to the sub-pixel for the video light ML.

Note that the polarizing plate 27 that limits polarization of the external light OL is provided on the external side of the light-guiding member 21.

The light source 10 and the light-guiding member 21 function as the backlight LL. In the present embodiment, the backlight LL, the transmissive liquid crystal panel 22, and the time-division half wavelength plate 28 function as the polarization separation member 41 that causes the video light ML and the external light OL to have different polarization components.

Note that the backlight LL may be a laser light source or the like.

The time-division half wavelength plate 28 is a device that performs a switch-type operation in response to a driving signal from the driving circuit 81 illustrated in FIG. 1, and switches the polarization direction of incident light between the first polarization direction and the second polarization direction that intersect each other according to the orientation direction of the liquid crystal, and causes the incident light to pass therethrough. The time-division half wavelength plate 28 includes the first liquid crystal wavelength plate 28a and the second liquid crystal wavelength plate 28b. The first and second liquid crystal wavelength plates 28a and 28b can be switched between the on state and the off state over the entire surface rather than on a pixel-by-pixel basis. When the time-division half wavelength plate 28 is in the off state of the first state, the time-division half wavelength plate 28 functions as a transparent flat plate as a whole, and transmits the video light ML while maintaining the polarization direction. On the other hand, when the time-division half wavelength plate 28 is in the on state of the second state, the time-division half wavelength plate 28 functions as a half wavelength plate having a principal axis in the middle between the X direction and the Y direction as a whole, and rotates the polarization direction of the external light OL by 90°.

Each of the first liquid crystal wavelength plate 28a and the second liquid crystal wavelength plate 28b constituting the time-division half wavelength plate 28 includes a liquid crystal layer sandwiched between a pair of base materials with transparent electrode layers interposed therebetween. The liquid crystal layer is, for example, an in-plane switching (IPS) type liquid crystal and the like, causes the first and second liquid crystal wavelength plates 28a and 28b to function as optical elements equivalent to half wavelength plates whose principal axes or fast axes are set in a specific direction (for example, in the middle between the X direction and the Y direction) when an electric field is applied, and causes the first and second liquid crystal wavelength plates 28a and 28b to function as isotropic parallel plates, when no electric field is applied.

The time-division half wavelength plate 28 is in the off state that is the first state in the video observation period, that is, at the timing at which the video light ML is incident, and the time-division half wavelength plate 28 maintains the original polarized state. The time-division half wavelength plate 28 is in the on state that is the second state in the external light observation period, that is, at the timing at which the external light OL is incident, and the time-division half wavelength plate 28 switches the polarized state.

When the display 40 is in the display state in the video observation period, the light-emitting elements 10r, 10g, and 10b of the light source 10 emit light, and the illumination light ILr, the illumination light ILg, and the illumination light ILb are supplied to the light-guiding member 21. At this timing, when the ferroelectric liquid crystal plate 12 is switched to the on state to be in the scattering state, the illumination light ILr, the illumination light ILg, and the illumination light ILb pass through, in the current polarized state, the first liquid crystal wavelength plate 28a of the time-division half wavelength plate 28 that is in the off state. Thereafter, the illumination light ILr, the illumination light ILg, and the illumination light ILb illuminate the liquid crystal modulation member 14 as the second polarized light P2 that is transversely polarized light or horizontally polarized light through the first polarizing plate 15 of the transmissive liquid crystal panel 22. The video light ML(R), the video light ML(G), and the video light ML(B) having passed through the liquid crystal modulation member 14 are obtained by rotating the polarization planes of the illumination light ILr, the illumination light ILg, and the illumination light ILb in response to the driving signal, and only the first polarized light P1 that is longitudinally polarized light or vertically polarized light is emitted through the second polarizing plate 16 and the second liquid crystal wavelength plate 28b of the time-division half wavelength plate 28. The video light ML(R), the video light ML(G), and the video light ML(B) emitted from the pixels of the transmissive liquid crystal panel 22 pass through the quarter wavelength plate 23 and are converted from the first polarized light P1 into the left-handed circularly polarized light LCP.

On the other hand, when the display 40 is in a non-display state in the external light observation period, the light source 10 is set to a non-emission state, that is, a turn-off state, and the supply of the illumination light IL to the light-guiding member 21 is stopped. At this timing, when the ferroelectric liquid crystal plate 12 is switched to the off state that is the second state and comes to be in the transmissive state, the external light OL travels straight so as to intersect the light-guiding member 21 and is incident on the first liquid crystal wavelength plate 28a of the time-division half wavelength plate 28. At this time, the external light OL is converted from the first polarized light P1 into the second polarized light P2 by the first liquid crystal wavelength plate 28a of the time-division half wavelength plate 28 in the on state. The external light OL having passed through the first liquid crystal wavelength plate 28a is incident on the transmissive liquid crystal panel 22. The external light OL having passed through the liquid crystal modulation member 14 has the rotated polarization plane, and only the first polarized light P1 that is longitudinally polarized light or vertically polarized light is emitted through the second polarizing plate 16. Thereafter, the external light OL is converted from the first polarized light P1 to the second polarized light P2 by the second liquid crystal wavelength plate 28b of the time-division half wavelength plate 28 in the on state. The external light OL emitted from the second liquid crystal wavelength plate 28b passes through the quarter wavelength plate 23 and is converted from the second polarized light P2 into the right-handed circularly polarized light RCP.

In the video observation period, the imaging system 50 is in a state of having a positive power, enabling observation of the video light ML. In addition, in the external light observation period, the imaging system 50 is in a state of having a power of substantially 0, enabling observation of the external light OL.

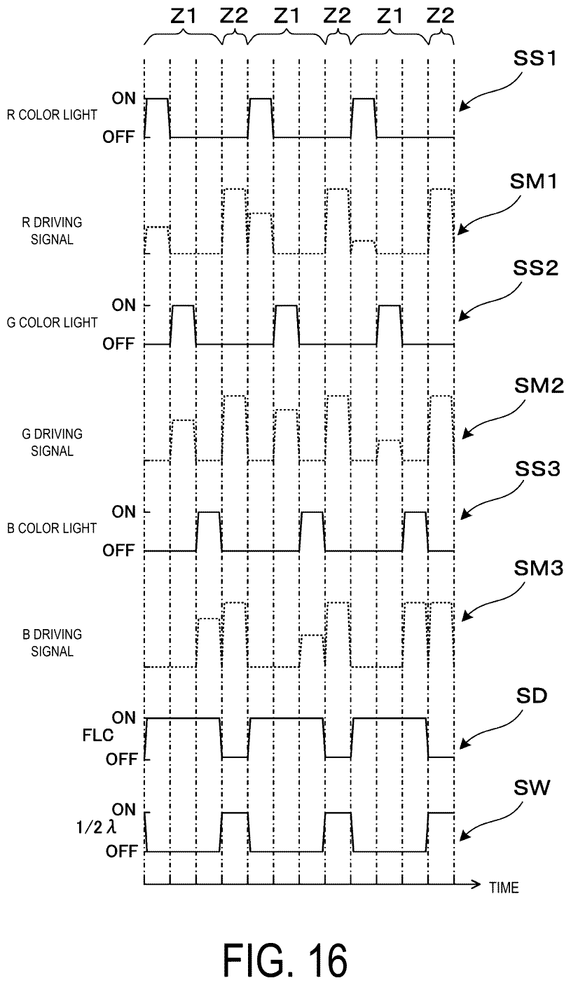

FIG. 16 is a timing chart for describing a display operation by the display optical system 103a. The horizontal axis represents time, and indicates, in order from the above, the blinking signal SS1 of the R light-emitting element 10r, an R driving signal SM1 for red display given to the liquid crystal modulation member 14, the blinking signal SS2 of the G light-emitting element 10g, a G driving signal SM2 for green display given to the liquid crystal modulation member 14, the blinking signal SS3 of the B light-emitting element 10b, a B driving signal SM3 for blue display given to the liquid crystal modulation member 14, the on/off signal SD of the ferroelectric liquid crystal plate (FLC) 12, and the on/off signal SW of the time-division half wavelength plate (1/2λ) 28. The operation of the first virtual image display device 100A includes a first sub-frame Z1 that is a sub-frame for video observation and a second sub-frame Z2 that is a sub-frame for external light observation in each frame.

In this case, when the first virtual image display device 100A is in a video observation period and the transmissive liquid crystal panel 22 is in a display state, the three colors of the video light ML(R), the video light ML(G), and the video light ML(B) are displayed in a time division manner, and when the first virtual image display device 100A is in an external light observation period and the transmissive liquid crystal panel 22 is in a non-display state, the external light OL is transmitted through the pixels of the transmissive liquid crystal panel 22 and an external image can be observed.

### Modification Examples and Others

These are descriptions of the present disclosure with reference to the embodiments. However, the present disclosure is not limited to the embodiments described above. It is possible to implement the present disclosure in various modes without departing from the spirit of the disclosure. For example, the following modifications are possible.

The display 40 and the composite display member 20 incorporated therein are not limited to those illustrated in FIG. 3 and the like, and various types of display panels can be employed.

In the imaging system 50, the polarizing diffractive lens 51 may be a polarizing diffractive lens GP1 illustrated in FIG. 6. In this case, the display 40 is configured such that the video light ML and the external light OL that are incident on the quarter wavelength plate 23 become the second polarized light P2 and the first polarized light P1, respectively. When the video light ML incident from the display 40 is the right-handed circularly polarized light RCP, the polarizing diffractive lens GP1 functions as an optical element having a positive power with respect to the video light ML, and inverts the rotation direction of the polarized light while reducing the divergence of the video light ML and then converts the video light ML into the left-handed circularly polarized light LCP. When the external light OL is the left-handed circularly polarized light LCP, the polarizing diffractive lens GP1 functions as an optical element having a negative power with respect to the external light OL, and inverts the rotation direction of the polarized light into the right-handed circularly polarized light RCP while reducing the convergence of the external light OL.

Although it has been assumed above that the HMD 200 is worn on the head and is used, the virtual image display devices 100A and 100B may also be used as a hand-held display that is not worn on the head and is to be looked into like binoculars. In other words, in the present disclosure, the head-mounted display also includes a hand-held display.

A virtual image display device according to a specific aspect includes a display configured to emit video light, and a polarization-selective lens that is disposed facing the display and that has a refractive power that selectively acts on polarized light of the video light, and the polarization-selective lens includes, in order from a display side, a polarizing diffractive lens having a positive refractive power with respect to the video light that is circularly polarized light and having a negative refractive power with respect to external light that is circularly polarized light, and an auxiliary lens having a positive refractive power equivalent to a refractive power of the polarizing diffractive lens.

In the virtual image display device described above, since the polarizing diffractive lens has a positive refractive power with respect to the video light that is the circularly polarized light from the display, and the auxiliary lens has a positive refractive power with respect to the video light that is the circularly polarized light and that has passed through the polarizing diffractive lens, even when the display is disposed in front of the eye, an image formed on a display surface of the display can be observed by an imaging system that is thin but has a short focal length. That is, the virtual image display device including the imaging system can be reduced in thickness. In addition, since the polarizing diffractive lens has a negative refractive power with respect to the external light that is the circularly polarized light and the auxiliary lens has a positive refractive power with respect to the external light that is the circularly polarized light and that has passed through the polarizing diffractive lens so as to cancel out the power of the polarizing diffractive lens, the external light can be observed.

In the virtual image display device according to the specific aspect, the display includes a polarization separation member that is disposed on the display side of the polarization-selective lens and that is configured to cause the video light and the external light to have different polarization components, and a quarter wavelength plate configured to convert predetermined linearly polarized light into predetermined circularly polarized light. In this case, the video light emitted from the display can be circularly polarized light.

In the virtual image display device according to the specific aspect, the polarizing diffractive lens has a distribution of refractive index anisotropy formed in a plane and is configured to generate a geometric phase corresponding to a lens shape on predetermined circularly polarized light.

In the virtual image display device according to the specific aspect, the auxiliary lens is configured to provide a refracting action to the video light changed from first circularly polarized light to second circularly polarized light through the polarizing diffractive lens.

In the virtual image display device according to the specific aspect, the polarizing diffractive lens is configured to convert the video light from left-handed circularly polarized light that is the first circularly polarized light into right-handed circularly polarized light that is the second circularly polarized light, and is configured to convert the external light from right-handed circularly polarized light that is the second circularly polarized light into left-handed circularly polarized light that is the first circularly polarized light. In this case, the polarizing diffractive lens converts the left-handed circularly polarized light of the incident video light into the right-handed circularly polarized light and emits the video light in a relatively converged state. In addition, the polarizing diffractive lens converts the right-handed circularly polarized light of the incident external light into the left-handed circularly polarized light and emits the left-handed circularly polarized light in a relatively diverged state.

In the virtual image display device in the specific aspect, the auxiliary lens is any one of a refractive lens and a diffractive lens.

In the virtual image display device according to the specific aspect, the refractive lens is any one of a convex lens and a Fresnel lens.

In the virtual image display device according to the specific aspect, the diffractive lens is any one of a Fresnel zone plate and a liquid crystal lens. In this case, the polarization-selective lens can be reduced in thickness.

In the virtual image display device according to the specific aspect, the polarization separation member is a polarization half mirror that is configured to reflect first polarized light, of the video light, in a specific direction toward the polarization-selective lens and that is configured to transmit second polarized light, of the external light, orthogonal to the first polarized light.

In the virtual image display device according to the specific aspect, the polarization separation member is an image display panel including a light emitting region configured to form the video light and a transmissive region configured to transmit the external light, and a pattern polarizing element that is disposed between the image display panel and the polarization-selective lens and that is configured to cause the light emitting region and the transmissive region to have different polarization components.

In the virtual image display device according to the specific aspect, the polarization separation member is a backlight, a liquid crystal panel including a video light generating pixel and an external light transmitting pixel, and a pattern polarizing element configured to cause the video light generating pixel and the external light transmitting pixel to have different polarization components.

In the virtual image display device according to the specific aspect, the polarization separation member is a backlight, a liquid crystal panel, a first liquid crystal wavelength plate disposed on an incident side of the liquid crystal panel, and a second liquid crystal wavelength plate disposed on an emission side of the liquid crystal panel, is configured to emit first polarized light in a specific direction in a case where the first liquid crystal wavelength plate and the second liquid crystal wavelength plate are in a first state when the video light is emitted by light emission of the backlight, and is configured to emit second polarized light orthogonal to the first polarized light in a case where the first liquid crystal wavelength plate and the second liquid crystal wavelength plate are in a second state when the external light is emitted in response to turning-off of the backlight.

An optical unit according to a specific aspect includes a display configured to emit video light, and a polarization-selective lens that is disposed facing the display and that has a refractive power that selectively acts on polarized light of the video light, and the polarization-selective lens includes, in order from a display side, a polarizing diffractive lens having a positive refractive power with respect to the video light that is circularly polarized light and having a negative refractive power with respect to external light that is circularly polarized light, and an auxiliary lens having a positive refractive power equivalent to a refractive power of the polarizing diffractive lens.

What is claimed is:

1. A virtual image display device comprising:
a display being configured to emit video light; and
a polarization-selective lens being disposed facing the display and having a refractive power that selectively acts on polarized light of the video light, wherein
the polarization-selective lens includes, in order from a display side,
a polarizing diffractive lens having a positive refractive power with respect to the video light that is circularly polarized light and having a negative refractive power with respect to the external light that is circularly polarized light, and
an auxiliary lens having a positive refractive power equivalent to a refractive power of the polarizing diffractive lens.

2. The virtual image display device according to claim 1, wherein
the display includes a polarization separation member that is disposed on the display side of the polarization-selective lens and that is configured to cause the video light and the external light to have different polarization components, and a quarter wavelength plate configured to convert predetermined linearly polarized light into predetermined circularly polarized light.

3. The virtual image display device according to claim 1, wherein
the polarizing diffractive lens has a distribution of refractive index anisotropy formed in a plane, and is configured to generate a geometric phase corresponding to a lens shape on predetermined circularly polarized light.

4. The virtual image display device according to claim 1, wherein
the auxiliary lens is configured to provide a refracting action to the video light changed from first circularly polarized light to second circularly polarized light through the polarizing diffractive lens.

5. The virtual image display device according to claim 4, wherein
the polarizing diffractive lens is configured to convert the video light from left-handed circularly polarized light that is the first circularly polarized light into right-handed circularly polarized light that is the second circularly polarized light, and is configured to convert the external light from right-handed circularly polarized light that is the second circularly polarized light into left-handed circularly polarized light that is the first circularly polarized light.

6. The virtual image display device according to claim 1, wherein
the auxiliary lens is any one of a refractive lens and a diffractive lens.

7. The virtual image display device according to claim 6, wherein
the refractive lens is any one of a convex lens and a Fresnel lens.

8. The virtual image display device according to claim 6, wherein
the diffractive lens is any one of a Fresnel zone plate and a liquid crystal lens.

9. The virtual image display device according to claim 2, wherein,
the polarization separation member is a polarization half mirror that is configured to reflect first polarized light, of the video light, in a specific direction toward the polarization-selective lens and that is configured to transmit second polarized light, of the external light, orthogonal to the first polarized light.

10. The virtual image display device according to claim 2, wherein
the polarization separation member is an image display panel including a light emitting region configured to form the video light and a transmissive region configured to transmit the external light, and a pattern polarizing element that is disposed between the image display panel and the polarization-selective lens and that is configured to cause the light emitting region and the transmissive region to have different polarization components.

11. The virtual image display device according to claim 2, wherein
the polarization separation member is a backlight, a liquid crystal panel including a video light generating pixel and an external light transmitting pixel, and a pattern polarizing element configured to cause the video light generating pixel and the external light transmitting pixel to have different polarization components.

12. The virtual image display device according to claim 2, wherein
the polarization separation member is a backlight, a liquid crystal panel, and a time-division half wavelength plate,
the time-division half wavelength plate includes a first liquid crystal wavelength plate disposed on an incident side of the liquid crystal panel and a second liquid crystal wavelength plate disposed on an emission side of the liquid crystal panel, and
the polarization separation member is configured to emit first polarized light in a specific direction in a case where the time-division half wavelength plate is in a first state when the video light is emitted by light emission of the backlight, and is configured to emit second polarized light orthogonal to the first polarized light in a case where the time-division half wavelength plate is in a second state when the external light is emitted in response to turning-off of the backlight.

13. An optical unit comprising:
a display configured to emit video light; and
a polarization-selective lens that is disposed facing the display and that has a refractive power that selectively acts on polarized light of the video light, wherein
the polarization-selective lens includes, in order from a display side,
a polarizing diffractive lens having a positive refractive power with respect to the video light that is circularly polarized light and having a negative refractive power with respect to external light that is circularly polarized light, and
an auxiliary lens having a positive refractive power equivalent to a refractive power of the polarizing diffractive lens.
